(19) United States
(12) Patent Application Publication
(10) Pub. No.: US 2010/0178009 A1
(43) Pub. Date: Jul. 15, 2010

(54) Polymer Layer at Fiber Ends in Fiber Optic Connectors and Related Methods

(76) Inventors: Masum Choudhury, Naperville, IL (US); Thomas R. Stanczyk, Lisle, IL (US); Malcolm H. Hodge, Chicago, IL (US)

Correspondence Address: MOLEX INCORPORATED, 2222 WELLINGTON COURT, LISLE, IL, 60532, US

(21) Appl. No.: 11/992,284

(22) PCT Filed: Dec. 12, 2006
(86) PCT No.: PCT/US06/47404

§ 371 Date: Mar. 25, 2010

Related U.S. Application Data
(60) Provisional application No. 60/817,816, filed on Jun. 30, 2006.

(51) Int. Cl. G02B 6/38; G02B 6/26

(52) U.S. Cl. 385/59; 264/1.25

(57) ABSTRACT

A connector (100) for a plurality of optic fibers (106-107) includes a polymer layer deposited over the ends of the fibers at the face of the connector (100) to reduce insertion loss. The polymer layer (110) may be a single layer which encompasses all of the ends of the plurality of fibers (106-107), or separate layers deposited at each of the ends of the plurality of fibers. These layers may be configured to be generally square, rectangular, circular or elliptical. Additional layers of the polymer may be deposited on the face between alignment hole and the housing.

### CROSS-REFERENCE TO RELATED APPLICATION

This patent application is a non-provisional of prior provisional patent application Ser. No. 60/817,816, filed on Jun. 30, 2006, the right of priority of which is hereby claimed for this patent application.

### FIELD OF THE INVENTION

The present invention relates generally to connectors for an optic fiber or for a plurality of optic fibers. More particularly, the present invention relates to a polymer layer deposited on the end of an optic fiber, or on the ends of a plurality of optic fibers to reduce insertion loss between a pair of mating connectors.

### BACKGROUND OF THE INVENTION

Insertion loss (IL) in prior art fiber optic connectors can vary across the end face to an unacceptable level depending upon the method of polishing the fiber optic ends. At low temperature operations, a thin layer of ice may also form in the air gaps between the ends of the optic fibers. Such layers of ice can change the performance of the connector and can increase the insertion loss to an unacceptably high level.

A general object of the present invention is to therefore provide a polymer layer on the end face of the connectors. The polymer layer may be a cured layer where the curing is accomplished through an ultraviolet (UV) or thermal process.

Another object of the present invention is to effectively remove any existing air gap between the fibers by using such a polymer layer on the end face of the connectors.

A further object of the present invention is to use the mechanical spring pressure of the connectors to substantially eliminate any air gaps between the fibers with the polymer layer.

Yet another object of the present invention is to substantially reduce the insertion loss between the fibers with the polymer layer.

A still further object of the present invention is to use the hydrophobic qualities of a polymer layer to prevent ice layer formation between the fibers at low temperature.

Another object of the present invention is to reduce the amount of time and labor required to manufacture a fiber optic connector which includes a polymer layer.

### SUMMARY OF THE INVENTION

The present invention is directed to a connector for an optic fiber, and, preferably, for a plurality of optic fibers, which includes a polymer layer deposited over the ends of the optic fibers. The polymer layer may be a cured polymer layer that has been cured using a thermal or ultraviolet (UV) process. The connector includes a housing, a face disposed in the housing, at least one optic fiber having an end disposed at the face, and a polymer layer deposited over an end of said at least one optic fiber. In one embodiment, a plurality of optic fibers each have an end disposed at the face, and a polymer layer deposited over each of the ends of the plurality of optic fibers.

The polymer layer may be a single layer which encompasses each of the ends of the plurality of optic fibers. For example, this single layer may be generally rectangular in configuration. Alternatively, separate polymer layers may be deposited at each of the ends of the plurality of optic fibers. These separate polymer layers may be configured to be generally square, rectangular, circular or elliptical about each fiber end.

The face of the connector may have at least one hole disposed therein and an additional layer of the polymer may be deposited between said at least one hole and the housing. Preferably, the polymer layer has a refractive index of about 1.4 to 1.5 at the wavelength of interest. the polymer layer may be have a thickness up to about 20 microns.

The present invention is further directed to methods of making a connector for an optic fiber a connector for an optic fiber, and, preferably, for a plurality of optic fibers, which includes a polymer layer deposited over the ends of the optic fibers. The polymer layer may be UV cured or thermally cured. The method includes the steps of providing a housing for the connector, disposing a face in the housing; disposing an end of at least one optic fiber at the face; and depositing a polymer layer over the end of said at least one optic fiber.

In one embodiment, the method is directed to a connector with a plurality of optic fibers, and the method includes the steps of disposing an end of each of the plurality of optic fibers at the face and depositing the polymer layer over each of the ends of the plurality of optic fibers. Another step may include encompassing each of the ends of the plurality of optic fibers with a single polymer layer, which may be rectangular in configuration.

In another embodiment, the method may include the step of depositing separate polymer layers at each of the ends of the plurality of optic fibers. These separate polymer layers may be configured to be generally square, rectangular, circular or elliptical about each fiber end.

In accordance with another aspect of the present invention, the method may include the steps of disposing at least one hole in said face and depositing an additional layer of the polymer between the said at least one hole and the housing. Other steps of the method include selecting the polymer layer to have a refractive index of about 1.4 to 1.5 at the wavelength of interest and depositing the polymer layer up to a thickness of about 20 microns.

### BRIEF DESCRIPTION OF THE DRAWINGS

The invention, together with its objects and the advantages thereof, may best be understood by reference to the following description taken in conjunction with the accompanying drawings, in which like reference numerals identify like elements in the figures, and in which:

FIG. 1 is an end view of a multiple fiber connector including polymer coating deposited on the end face in a generally rectangular pattern about the multiple fibers in accordance with the present invention;

FIGS. 2 is an end view of a multiple fiber connector including polymer coating on the end face in a generally rectangular pattern about the multiple fibers in a manner similar to FIG. 1, but including an additional polymer coated area on the end face of the connector between each guide hole and the connector housing in accordance with another aspect of the present invention;

FIG. 3 is an end view of a multiple fiber connector similar to FIG. 1, but with the polymer coating on the end face consisting of a generally square pattern of polymer coating about each of the multiple fibers in accordance with a further aspect of the present invention;

FIG. 4 is an end view of a multiple fiber connector similar to FIG. 1, but with polymer coating on the end face consisting of a generally circular pattern of polymer coating about each of the multiple fibers in accordance with yet another aspect of the present invention; and

FIG. 5 is a side view of the multiple fiber connectors shown in FIGS. 1 through 4.

### DESCRIPTION OF THE PREFERRED EMBODIMENTS

It will be understood that the present invention may be embodied in other specific forms without departing from the spirit thereof. The present examples and embodiments, therefore, are to be considered in all respects as illustrative and not restrictive, and the invention is not to be limited to the details presented herein.

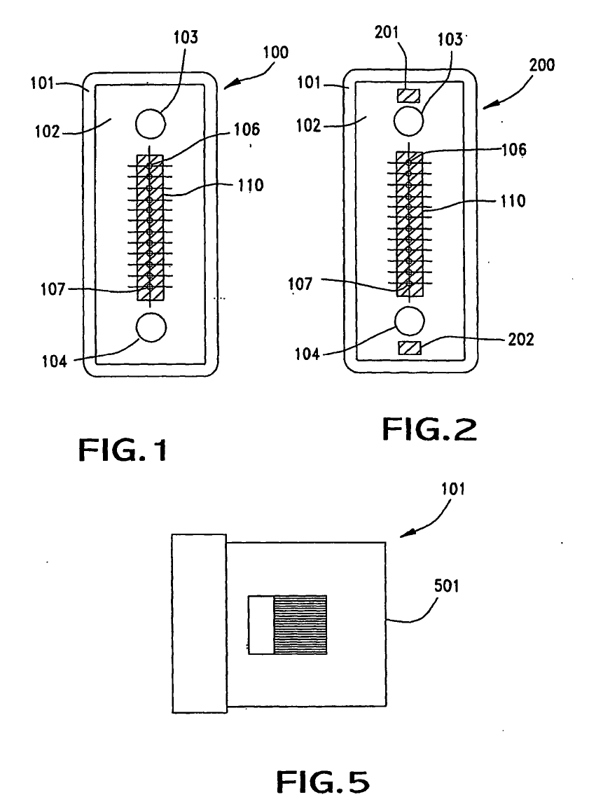

With reference, to FIG. 1, a connector, generally designated 100, is illustrated. In the illustrated embodiment of FIG. 1, connector 100 may consist of an outer shell or housing 101 formed from any appropriate material. Internally within housing 100 is a generally planar face 102 of the connector. Disposed within face 102 may be the ends of a plurality of optical fibers, such as the uppermost fiber 106 and the lowermost fiber 107. In the example of FIG. 1, the ends of twelve fibers, including fibers 106 and 107 are presented at the face 102 between the alignment holes 103-104. For example, the ends of the plurality of fibers may be generally in alignment with the centers of the alignment holes 103-104. The ends of the fibers may also have generally equal spacing between each pair of adjacent fiber ends.

In a manner know to the art, the pair of alignment holes 103 and 104 in face 102 is used for receiving and aligning a mating connector (not shown) to connector 100 such that the fiber ends, including fiber ends 106 and 107, will be in alignment with corresponding fiber ends in the mating connector and in close proximity therewith.

In accordance with one aspect of the present invention, a polymer layer 110 is deposited at the end of an optic fiber, or at the ends of a plurality of optic fibers such as fibers 106 and 107. It should be noted that the polymer layer may be a cured polymer layer where the curing is done using thermal or ultraviolet (UV) curing. For purposes of the present discussion, and by way of example only, UV cured polymer layers are used throughout. However, it should be noted that thermal curing is a viable alternative as well, where infra-red lamps, for example, may be used for curing a heat sensitive polymer.

As shown in FIG. 1, the UV cured polymer layer 110 is deposited between the alignment holes 103 and 104. It is single UV cured polymer layer, which is generally rectangular in configuration and encompasses all twelve of the fiber ends presented at the face 102, including fiber ends 106 and 107. Preferably, this UV cured polymer layer is thin and flexible and has a refractive index of about 1.4 to 1.5 at the wavelength of interest, such as at about 850 nm to 1550 nm. For example, the UV cured polymer layer may have a thickness up to about 20 microns.

The connector 100 in FIG. 1 is similar to the connector 200 shown in FIG. 2. However, additional areas 201 and 202 of the UV cured polymer layer have been deposited between the hole 103 and the housing 101 and between the hole 104 and the housing 101. While these additional UV cured polymer layers 201 and 202 are illustrated in FIG. 2 as being rectangular in shape, any desired shape may be employed. These additional areas may assist in ensuring that a face of a mating connector rests flatly against the UV cured polymer layer 110 when connector 200 is mated with another connector. That is the raised height of face 102 due to the deposition of the UV cured polymer layer 110 will be matched by the corresponding raised height at areas 201 and 202.

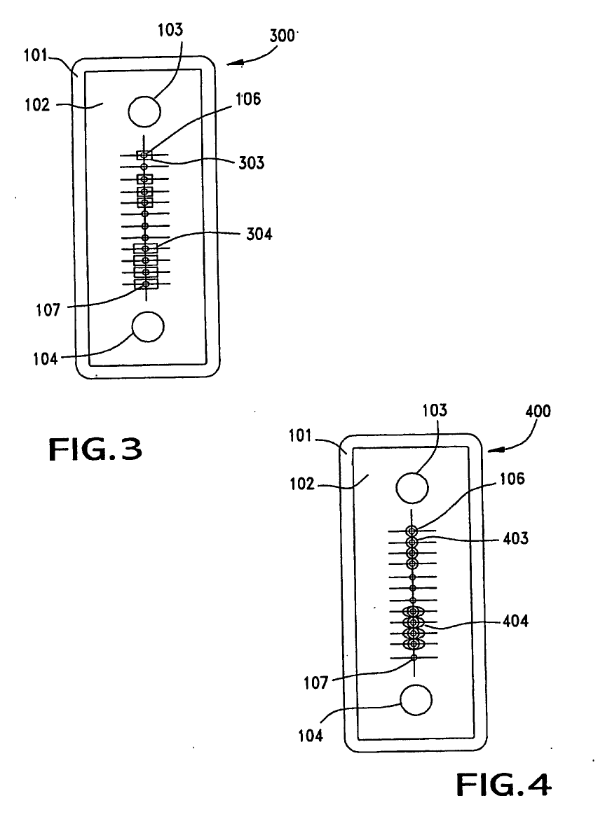

Connector 300 in FIG. 3 is similar in many respects to connectors 100 and 200 in FIGS. 1 and 2, respectively. However, the face 102 of connector 300 has an individual or separate UV cured polymer layer 303 or 304 deposited at the end of each fiber, such as at the end of fiber 106, rather than the single UV cured polymer layer 110 which encompasses all of the fiber ends as shown in FIGS. 1 and 2. As illustrated in FIG. 3, the separate UV cured polymer layers 303 or 304 may be generally square or rectangular in configuration, respectively. If desired, an additional UV cured polymer layer, which may be similar to the layers 303, may be deposited between each of holes 103 and 104, as illustrated in FIG. 2.

Connector 400 in FIG. 4 is similar in many respects to connector 300 in FIG. 3. The face 102 of connector 400 also has individual UV cured polymer layers 403 or 404 deposited at the end of each fiber, such as at the end of fiber 106, rather than a single UV cured polymer layer 110 to encompass all of the fiber ends as in FIGS. 1 and 2. However, as illustrated in FIG. 4, the separate UV cured polymer layers 403 or 404 may be generally circular or elliptical in configuration, respectively. If desired, an additional UV cured polymer layer, which may be similar to the layers 403, may be deposited between each of holes 103 and 104, as illustrated in FIG. 2.

It will be appreciated by those skilled in the art that, while the separate UV cured polymer layers 303 in FIGS. 3 and 403 in FIG. 4 are illustrated as being square, rectangular, circular or elliptical in shape, other desired shapes may be similarly employed to also achieve the advantages of the present invention.

FIG. 5 is a side view of a typical housing 101 used in connectors 100, 200, 300 and 400 shown in FIGS. 1-4. Housing 101 may be formed or fabricated from any suitable material, as is known in the art. Face 102 in FIGS. 1-4 may be flush with a mating end 501 of the housing 101, or face 102 may be recessed within the housing.

The UV cured polymer layer 110, 303 or 403 acts as a cushion for a corresponding or opposing fiber in a mating connector, or for a plurality of fibers in a mating connector, when the fibers contact corresponding or opposing fibers for fiber optic connection between respective pairs of optic fibers in the pair of mating connectors. The UV cured polymer layer 110, 303 or 403, thus effectively removes any existing air gap between the ends of respective pairs of optic fibers, which are in communication with each other. The spring pressure typically exerted by connectors may also be utilized to substantially remove or eliminate any air gap between the optic fibers in mating connectors.

With the air gap between respective pairs of optic fibers substantially removed, the insertion loss across the end face of the connector is also substantially reduced or eliminated. The insertion loss may also become quite uniform. When the polymer layer is deposited relatively uniformly on the end face of the connectors, any air gap between opposing fibers of the respective connectors due to polishing edge effects on the ends of the optic fibers is also substantially reduced or eliminated.

In accordance with another aspect of the present invention, two single optic fibers may be connected within a ferrule, such as an LC ferrule with about a 1.25 mm diameter, with one of the optic fibers having a UV cured polymer layer and with the other opposing optic fiber having a cleaved end. That is, the opposing fiber does not need to have a polished end. The flexible UV cured polymer layer accommodates the cleaved end of the opposing fiber with low insertion loss when the cleaved end is inserted into the ferrule to contact the polymer layer.

Such a UV cured polymer layer 110, 303 or 403 is also hydrophobic. This property may be utilized to assist fiber optic connectors, including one or more optic fibers having a UV cured polymer layer, to perform adequately at low temperature without the formation of any ice layer between the ends of the optic fibers having the UV cured polymer layer and the opposing optic fibers. Of course, any ice layer has a refractive index of 1.0, which will cause a substantial insertion loss if an ice layer forms between the ends of opposing fibers. The UV cured polymer layer therefore assists in avoiding formation of any ice layer between the ends of opposing optic fibers and avoids any change in the insertion loss between the respective pairs of optic fibers.

The present invention also saves time and labor in fabricating a connector for optic fibers. For example, the prior art techniques of polishing the face of the connector and the fiber ends, such as with a diamond abrasive disk or the like, are time consuming. For best adhesion of the UV cured polymer layer, such as layer 110 on face 102 in FIG. 1, the surface of face 102 is preferably somewhat rough. Thus, the layer 110 may be deposited on the face 102 without any time-consuming polishing of the face 102, or the face 102 may be partially polished, if desired. When deposited on a rough or partially polished face 102, the UV cured polymer layer 110 provides a surface that is quite smooth and no further polishing is needed or required. If desired, the UV cured polymer layer 110 can also be deposited over a polished surface.

While particular embodiments of the invention have been shown and described, it will be obvious to those skilled in the art that changes and modifications may be made therein without departing from the invention in its broader aspects.

1. A connector for an optic fiber, said connector comprising:
a housing for the connector;
a face disposed in the housing;
at least one optic fiber having an end disposed at the face; and
a polymer layer deposited over an end of said at least one optic fiber.

2. The connector in accordance with claim 1 wherein said at least one optic fiber comprises a plurality of optic fibers with each of the plurality of optic fibers having an end disposed at the face.

3. The connector in accordance with claim 2, wherein said polymer layer is deposited over each of the ends of the plurality of optic fibers.

4. The connector in accordance with claim 3, wherein said polymer layer is generally rectangular in configuration.

5. The connector in accordance with claim 4, wherein said generally rectangular polymer layer encompasses each of the ends of the plurality of optic fibers.

6. The connector in accordance with claim 3, wherein said face has at least one hole disposed therein and an additional layer of the polymer is deposited between the said at least one hole and the housing.

7. The connector in accordance with claim 2, said polymer layer comprises a separate layer disposed at each of the ends of the plurality of optic fibers.

8. The connector in accordance with claim 7, wherein said separate layer disposed at each of the ends of the plurality of optic fibers is generally square or rectangular in configuration.

9. The connector in accordance with claim 7, wherein said separate layer disposed at each of the ends of the plurality of optic fibers is generally circular or elliptical in configuration.

10. The connector in accordance with claim 1, wherein said ultraviolet cured polymer layer is up to about 20 microns in thickness.

11. The connector in accordance with claim 1, wherein said polymer layer is deposited over an unpolished or partially polished surface of the face.

12. The connector in accordance with claim 1, wherein said polymer layer has a refractive index of about 1.4 to 1.5 at the wavelength of interest.

13. A method of making a connector for an optic fiber, said method comprising the steps of:
providing a housing for the connector;
disposing a face in the housing;
disposing an end of at least one optic fiber at the face; and
depositing a polymer layer over the end of said at least one optic fiber.

14. The method in accordance with claim 13 wherein said at least one optic fiber comprises a plurality of optic fibers, the method further comprising the additional step of:
disposing an end of each of the plurality of optic fibers at the face.

15. The method in accordance with claim 14, the method further comprising the additional step of:
depositing said polymer layer over each of the ends of the plurality of optic fibers.

16. The method in accordance with claim 15, the method further comprising the additional step of:
configuring said polymer layer to be generally rectangular.

17. The method in accordance with claim 16, the method further comprising the additional step of:
encompassing each of the ends of the plurality of optic fibers with said generally rectangular polymer layer.

18. The method in accordance with claim 15, the method further comprising the additional steps of:
disposing at least one hole in said face; and
depositing an additional layer of the polymer between the said at least one hole and the housing.

19. The method in accordance with claim 14, the method further comprising the additional step of:
depositing a separate polymer layer at each of the ends of the plurality of optic fibers.

20. The method in accordance with claim 19, the method further comprising the additional step of:
configuring said separate polymer layer at each of the ends of the plurality of optic fibers to be generally square or rectangular.

21. The method in accordance with claim 19, the method further comprising the additional step of:
configuring said separate polymer layer at each of the ends of the plurality of optic fibers to be generally circular or elliptical.

22. The method in accordance with claim 13, the method comprising the additional step of depositing the polymer layer up to a thickness of about 20 microns.

23. The method in accordance with claim 13, the method comprising the additional step of depositing the polymer layer over an unpolished or partially polished surface of the face.

24. The method in accordance with claim 13, the method comprising the additional step of selecting the polymer layer to have a refractive index of about 1.4 to 1.5 at the wavelength of interest.

25. The connector in accordance with claim 1 wherein said polymer layer is a cured polymer layer.

26. The connector in accordance with claim 25 wherein said polymer layer is UV cured.

27. The connector in accordance with claim 25 wherein said polymer layer is thermally cured.
